(19) United States
(12) Patent Application Publication
(10) Pub. No.: US 2023/0238160 A1
(43) Pub. Date: Jul. 27, 2023

(54) Sintered NdFeB permanent magnet and preparation method thereof

(71) Applicant: Yantai Dongxing Magnetic Materials Inc., Yantai (CN)

(72) Inventors: Chunjie XIANG, Yantai (CN); Zhongjie PENG, Yantai (CN); Xiaonan ZHU, Yantai (CN); Kaihong DING, Yantai (CN)

(21) Appl. No.: 18/098,718

(22) Filed: Jan. 19, 2023

(30) Foreign Application Priority Data
Jan. 24, 2022 (CN) 202210078227.2

(51) Int. Cl. H01F 1/057; H01F 41/02; B22F 3/16; B22F 1/05; C22C 38/14; C22C 38/10; C22C 38/06; C22C 38/00; C22C 38/16

(52) U.S. Cl. CPC H01F 1/0577; H01F 41/0266; B22F 3/16; B22F 1/05; C22C 38/14; C22C 38/10; C22C 38/06; C22C 38/005; C22C 38/16; C22C 38/002; B22F 2998/10; B22F 2201/20; B22F 2202/05; B22F 2003/248

(57) ABSTRACT

The disclosure discloses a NdFeB permanent magnet and a preparation method thereof. The magnet is composed of main phase I, a shell structure, a grain boundary phase adjacent to the shell structure, a main phase II, a Ga rich region and a Cu rich region. The magnet has high remanence, high coercivity, and high magnetic energy. In addition, this method can significantly reduce the production cost.

### BACKGROUND OF THE INVENTION

### 1. Field of the Invention

The present disclosure belongs to the technical field of sintered NdFeB permanent magnets, in particular relates to a method for improving the magnetic properties by improving the morphologic structure of magnets.

### 2. Description of the Prior Art

Due to their excellent magnetic properties, NdFeB magnets are used in many technical fields such as motors, information technology, medical devices, etc. To meet the demand for high performance magnets for wind power and high energy motors, the demand for NdFeB magnets with low cost and high performance is increasing rapidly. Therefore, how to reduce the consumption of heavy rare earths or realise the non-heavy rare earths in magnets is a current research focus. After the research, we develop a method to improve the magnetic properties by improving the organizational structure.

Chinese application CN104952607A relates to a process for producing low melting point magnets from a light rare earth copper alloy as a grain boundary phase, which can be sintered at low temperature due to the wettability and low melting point of the light rare earth copper alloy. Chinese application CN109102976A describes a process for manufacturing magnets, using a similar process, but the additive alloy contains heavy rare earths. Therefore, the magnetic property is improved using heavy rare earths. Chinese application CN106024253A relates to a process for producing magnets in which the high Ha compound is applied to the surface of the magnet for diffusion so that the high Ha element (Dy, Tb, Ho) diffuses through the grain boundary and forms a shell structure in the outer layer of the main phase, thereby increasing the coercivity of the magnet with a lower content of heavy rare earths. Another Chinese application CN112992463A discloses a method for producing an NdFeB magnet, wherein the magnet with heavy rare earth elements is subjected to diffusion treatment and the diffusion source also contains heavy rare earth elements.

However, the above methods have many shortcomings, e.g. the remanence decreases sharply with increasing amount of addictive alloys, or the coercivity of the magnet is still improved by heavy rare earth elements, or the structure of the magnet is changed by interfacial diffusion to improve the coercivity of the magnet, but the cost of the grain boundary diffusion method is high.

### SUMMARY OF THE INVENTION

The present disclosure provides a manufacturing process for sintered NdFeB permanent magnets to overcome at least some of the above disadvantages. The disclosure can improve the microstructure of the magnet by conventional sintering methods and produce high performance magnets without using high amounts of heavy rare earths.

A first aspect of the present disclosure is to provide a sintered NdFeB magnet as defined in claim 1. The sintered NdFeB magnet comprises:

a main phase I consisting of Re₂Fe₁₄B, where Re is Nd or Pr and Nd;

a shell structure covering at least partially an outer layer of main phase I, the shell structure consisting of (PrNd)₂Fe₁₄B and having a thickness of 0.1-2 μm, and wherein the amount of

Pr in the shell structure is 1 wt %˜7 wt %;

a grain boundary phase adjacent to shell structure;

a main phase II consisting of Pr₂Fe₁₄B;

a Ga rich region and a Cu rich region in a trigonal junction,

the amounts of Ga, Cu and Al in the Ga rich region are 2 wt %˜5 wt %, 0˜0.3 wt %, and 0˜1 wt %, respectively, and wherein a total mass fraction of Ga, Cu and Al is 2 wt %-6 wt % of the total mass of the Ga rich region;

the amounts of Ga, Cu and Al in the Cu rich region are 0 wt %˜0.4 wt %, 1 wt˜9 wt %, and 0˜0.5 wt %, respectively, and wherein a total mass fraction of Ga, Cu and Al is 2 wt %-9.9 wt % of the total mass of the Cu rich region;

a total mass of main phase I, shell structure, grain boundary phase, main phase II, Ga rich region and Cu rich region makes more than 97 wt. % of the NdFeB magnet and, if any, a residue comprises NdO, NdN, and unavoidable impurities.

The total mass of main phase I, shell structure, grain boundary phase, main phase II, Ga rich region and Cu rich region may be X₁, the total mass of NdFeB may be X₂, 97%<X₁/X₂<100%; The rest of NdFeB magnets are Nd—O, Nd—N, etc.

According to an embodiment, the composition of the NdFeB magnet is in weight percentage (Pr₁₋ₓNdₓ)ₐ₁—Fe_{1-a1-b1-c1}—B_{b1}-M1_{c1},

where x is the weight fraction of Nd of the total weight of Nd and Pr,

a1, b1 and c1 are the weight fractions in the NdFeB magnet composition,

M1 is at least Ga and Cu and, optionally, further includes at least one of Al, Co, Ti, Zr, V, Mo, and Nb,

70%<x<100%, 29.6≤1≤33%; 0.86%≤b1≤0.98%; and 0.5%≤c1≤4.5%, and

and the balance is Fe and unavoidable impurities.

A mass ratio of Ga, Cu and Al may fit the condition 1<(Ga+Al)/Cu≤8.

According to another aspect of the present disclosure, there is provided a method for producing the above-mentioned sintered NdFeB magnet. The method is defined in claim 4 and comprises the steps of:

(S1) Preparing a main alloy and an additive alloy by a strip casting process:

a composition of the additive alloy is in weight percentage Reₐ₂—Fe_{1-a2-b2-c2}B_{b2}-M2_{c2}, 38%≤a2≤50%; 0.35%≤b2≤1%; 2.5%≤c2≤12%; where Re is Pr or Pr and Nd, and when Re contains Nd, a mass fraction of Pr is >50 wt. %;

M2 is at least Ga and Cu and, optionally, further includes at least one of Al, Co, Ti, Zr, V, Mo, and Nb, wherein a total mass of Al, Cu, Ga is X₃, a total mass of M2 is X₄, and a ratio of X₃ to X₄ is 0.35<X₃/X₄<1; and

a composition of the main alloy is approximate to Nd₂Fe₁₄B, and

(S2) Preparing NdFeB powder by hydrogen treatment and jet milling of the main alloy and the additive alloy, wherein the powder includes 82 wt %-95 wt % of the main alloy and 5 wt %-18 wt % of the additive alloy, wherein the ratio and the composition of the main alloy and the additive alloy are selected such that the magnet has the composition (Pr₁₋ₓNdₓ)ₐ₁—Fe_{1-a1-b1-c1}—B_{b1}-M1_{c1},

where x is the weight fraction of Nd of the total weight of Nd and Pr,

a1, b1 and c1 are the weight fractions in the NdFeB magnet composition,

M1 is at least Ga and Cu and, optionally, further includes at least one of Al, Co, Ti, Zr, V, Mo, and Nb;

(S3) Compressing the NdFeB powder of step (S2) into compacts while applying an orienting magnetic field; and

(S4) Sintering the compacts in a vacuum furnace and then aging the sintered compacts to obtain the NdFeB magnet.

A mass ratio of Ga, Cu and Al may fit the condition 1<(Ga+Al)/Cu≤8.

The strip casting process of step (S1) may be performed under argon, and a melting temperature may be 1400 to 1500° C.

The NdFeB powder after jet milling process of step (S2) may have an average particle size of D50 of 2.5 μm to 5 μm. The average particle diameter (D50) of the particles may be measured by laser diffraction (LD). The method may be performed according to ISO 13320-1. According to the IUPAC definition, the equivalent diameter of a non-spherical particle is equal to a diameter of a spherical particle that exhibits identical properties to that of the investigated non-spherical particle.

The orienting magnetic field of step (S3) may be 1.8 to 2.5 T.

A sintering temperature may be 1020° C. to 1060° C. and a sintering time may be 6 to 12 h in step (S4).

The aging in step (S4) may include a first heat treatment at 800° C. to 900° C. for 3 to 5 hours and a second heat treatment at 440° C. to 540° C. for 3 to 6 hours.

The main alloy and additive alloy flakes can be mixed and then subjected to hydrogen treatment and jet milling, or the main alloy and additive alloy are respectively subjected to hydrogen treatment, and then mixed for jet milling, or the main alloy and additive alloy are respectively subjected to hydrogen treatment and jet milling, then mixing the powder.

A shell structure is formed on the outer layer of the main phase grain by controlling the composition and structure of the additive alloy, and the magnet still maintains a high remanence when the coercivity increases. On the other hand, the distribution of grain boundary phase is improved for the low melting point phase, thus enhancing the coercivity. The present disclosure can effectively reduce the usage amount of heavy rare earth and reduce the production cost.

### BRIEF DESCRIPTION OF THE FIGURES

FIG. 1 is a microstructure image of a sintered NdFeB magnet according to Example 1 of the present disclosure.

FIG. 2 illustrates the distribution of elemental Pr in the sintered NdFeB magnet according to Example 1 of the present disclosure.

FIG. 3 illustrates the distribution of elemental Pr in the sintered NdFeB magnet according to Comparative Example 1.

### DETAILED DESCRIPTION OF THE INVENTION

In the following, further detailed descriptions of the present disclosure are given. It shall be noted that the embodiments are used only to interpret the present disclosure and do not have any limiting effect on it.

### Example 1

The preparation method of a sintered NdFeB magnet comprises the steps of:

(1) Strip casting process: The alloy sheets are prepared by a strip casting process at a melting temperature of 1450° C., wherein the average thickness of the alloy sheet is about 0.3 mm. The composition and mixing ratio of main alloy and additive alloy are shown in Table 1, the composition of main alloy and additive alloy after mixing is shown in Table 2.

(2) Hydrogen treatment and jet milling process: After mixing the main alloy and auxiliary alloy in proportion, the alloy sheets are subjected to hydrogen desorption process to break into smaller pieces. After the decrepitation process, the alloy powders are pulverized in a jet milling step under nitrogen to prepare an alloy powder having an average particle size D50 of 4.0 μm.

(3) Compaction process: The powder above mentioned is compressed into compacts under the protection of nitrogen gas while applying an orienting magnetic field of 1.8 T.

(4) Sintering and aging process: The compacts are subjected to a sintering step in a vacuum furnace at a temperature of 1040° C. for 11 hours, then argon is pumped for rapid cooling. Then, the sintered compacts are treated by a first heat treatment step at 850° C. for 3 hours, and a second heat treatment step at 460° C. for 3 hours to obtain the NdFeB magnet. The magnet comprises main phase I, shell structure with thickness of 0.1˜2 μm, grain boundary phase, main phase II, Ga rich region and Cu rich region.

### Example 2

The composition and mixing ratio of main alloy and additive alloy are shown in Table 1, the composition of main alloy and additive alloy after mixing is shown in Table 2, the secondary aging temperature is shown in Table 3, and other process conditions are the same as those in Example 1 to obtain the sintered NdFeB Magnet.

### Example 3

The composition and mixing ratio of main alloy and additive alloy are shown in Table 1, the composition of main alloy and additive alloy after mixing is shown in Table 2, the secondary aging temperature is shown in Table 3, and other process conditions are the same as those in Example 1 to obtain the sintered NdFeB Magnet.

### Example 4

The composition and mixing ratio of main alloy and additive alloy are shown in Table 1, the composition of main alloy and additive alloy after mixing is shown in Table 2, the secondary aging temperature is shown in Table 3, and other process conditions are the same as those in Example 1 to obtain the sintered NdFeB Magnet.

### Example 5

The composition and mixing ratio of main alloy and additive alloy are shown in Table 1, the composition of main alloy and additive alloy after mixing is shown in Table 2, the secondary aging temperature is shown in Table 3. In step of (S2), the main alloy and additive alloy are respectively subjected to hydrogen treatment and jet milling, the particle size of D50 of the main alloy powder and additive alloy powder is 4.0 μm and 3.0 μm, respectively, and other process conditions are the same as those in Example 1 to obtain the sintered NdFeB Magnet.

TABLE 1
The compositions and mixing ratios of main alloy and additive alloy (wt %)

| | | | | | | Ga + | | | | | ratio |
|---|---|---|---|---|---|---|---|---|---|---|---|
| | | Al | B | Co | Fe | Cu | Ti | Nd | Pr | ΣRe | (wt %) |
| Example 1 | main | 0.05 | 0.94 | 0.10 | bal. | 0.32 | 0.00 | 23.36 | 5.84 | 29.20 | 95.00 |
| | alloy | | | | | | | | | | |
| | additive | 0.05 | 0.90 | 0.45 | bal. | 2.00 | 0.00 | 0.00 | 38.00 | 38.00 | 5.00 |
| | alloy | | | | | | | | | | |
| Example 2 | main | 0.20 | 0.90 | 0.00 | bal. | 0.27 | 0.00 | 23.44 | 5.86 | 29.30 | 93.00 |
| | alloy | | | | | | | | | | |
| | additive | 0.50 | 0.85 | 0.00 | bal. | 5.00 | 0.00 | 10.00 | 32.00 | 42.00 | 7.00 |
| | alloy | | | | | | | | | | |
| Example 3 | main | 0.12 | 0.98 | 0.50 | bal. | 0.22 | 0.00 | 23.60 | 5.90 | 29.50 | 91.50 |
| | alloy | | | | | | | | | | |
| | additive | 0.50 | 1.00 | 0.50 | bal. | 6.50 | 0.00 | 10.00 | 35.00 | 45.00 | 8.50 |
| | alloy | | | | | | | | | | |
| Example 4 | main | 0.30 | 0.95 | 0.50 | bal. | 0.10 | 0.20 | 29.50 | 0.00 | 29.50 | 88.00 |
| | alloy | | | | | | | | | | |
| | additive | 0.50 | 0.65 | 0.50 | bal. | 6.00 | 0.30 | 5.00 | 40.00 | 45.00 | 12.00 |
| | alloy | | | | | | | | | | |
| Example 5 | main | 0.52 | 0.97 | 1.70 | bal. | 0.10 | 0.44 | 24.97 | 4.30 | 29.27 | 82.00 |
| | alloy | | | | | | | | | | |
| | additive | 1.80 | 0.35 | 4.20 | bal. | 5.50 | 0.50 | 24.00 | 26.00 | 50.00 | 18.00 |
| | alloy | | | | | | | | | | |

TABLE 2
The magnet compositions of Examples 1 to 5 (wt %)

| | | Al | B | Co | Cu | Fe | Ga | Ti | Nd | Pr | ΣRe |
|---|---|---|---|---|---|---|---|---|---|---|---|
| Example 1 | magnet | 0.05 | 0.94 | 0.12 | 0.10 | bal. | 0.30 | 0.00 | 22.19 | 7.45 | 29.64 |
| Example 2 | magnet | 0.22 | 0.90 | 0.00 | 0.20 | bal. | 0.40 | 0.00 | 22.50 | 7.69 | 30.19 |
| Example 3 | magnet | 0.15 | 0.98 | 0.50 | 0.10 | bal. | 0.65 | 0.00 | 22.44 | 8.37 | 30.82 |
| Example 4 | magnet | 0.32 | 0.91 | 0.50 | 0.31 | bal. | 0.50 | 0.21 | 26.56 | 4.80 | 31.36 |
| Example 5 | magnet | 0.75 | 0.86 | 2.15 | 0.46 | bal. | 0.61 | 0.45 | 24.80 | 8.20 | 33.00 |

TABLE 3
The secondary aging temperature in Examples 1 to 5

| | Exam- | Exam- | Exam- | Exam- | Exam- |
|---|---|---|---|---|---|
| | ple 1 | ple 2 | ple 3 | ple 4 | ple 5 |
| Secondary | 460° C. | 450° C. | 460° C. | 460° C. | 470° C. |
| aging | | | | | |
| temperature | | | | | |

### Comparative Example 1

(1) Strip casting process: The alloy sheets are prepared by a strip casting process at the melting temperature of 1450° C., wherein the average thickness of the alloy sheet is about 0.3 mm. The composition of comparative example 1 is the same as that of the example 1 after mixing the main alloy and additive alloy shown in Table 2, and the composition of the alloy is listed in Table 4.

(2) Hydrogen treatment and jet milling process: The alloy sheets are subjected to hydrogen desorption process to break into smaller pieces. After the decrepitation process, the alloy powders are pulverized in a jet milling step under nitrogen to prepare an alloy powder having a particle size of D50=4.0 μm.

(3) Compaction process: The powder above mentioned is compressed into compacts under the protection of nitrogen while applying an orienting magnetic field of 1.8 T.

(4) Sintering and aging process: The compacts are subjected to a sintering step in a vacuum furnace at a temperature of 1040° C. for 11 hours, then argon is pumped for rapid cooling. The sintered compacts are treated by a first heat treatment step at 850° C. for 3 hours, and a second heat treatment step at 460° C. for 3 hours to obtain the NdFeB magnet.

### Comparative Example 2

The composition of comparative example 2 is the same as that of the example 2 after mixing the main alloy and additive alloy shown in Table 2, the composition of alloy is listed in Table 4, the secondary aging temperature is listed in Table 5, and other process conditions are the same as those in Comparative Example 1 to obtain the sintered NdFeB Magnet.

### Comparative Example 3

The composition of comparative example 3 is the same as that of the example 3 after mixing the main alloy and additive alloy shown in Table 2, the composition of alloy is listed in Table 4, the secondary aging temperature is listed in Table 5, and other process conditions are the same as those in Comparative Example 1 to obtain the sintered NdFeB Magnet.

### Comparative Example 4

The composition of comparative example 4 is the same as that of the example 4 after mixing the main alloy and additive alloy shown in Table 2, the composition of alloy is listed in Table 4, the secondary aging temperature is listed in Table 5, and other process conditions are the same as those in Comparative Example 1 to obtain the sintered NdFeB Magnet.

### Comparative Example 5

The composition of comparative example 5 is the same as that of the example 5 after mixing the main alloy and additive alloy shown in Table 2, the composition of alloy is listed in Table 4, the secondary aging temperature is listed in Table 5, and other process conditions are the same as those in Comparative Example 1 to obtain the sintered NdFeB Magnet.

TABLE 4
The magnet compositions of Comparative Examples 1 to 5 (wt %)

| | | Al | B | Co | Cu | Fe | Ga | Ti | Nd | Pr | ΣRe |
|---|---|---|---|---|---|---|---|---|---|---|---|
| Comparative | magnet | 0.05 | 0.94 | 0.12 | 0.10 | bal. | 0.30 | 0.00 | 22.19 | 7.45 | 29.64 |
| Example 1 | | | | | | | | | | | |
| Comparative | magnet | 0.22 | 0.90 | 0.00 | 0.20 | bal. | 0.40 | 0.00 | 22.50 | 7.69 | 30.19 |
| Example 2 | | | | | | | | | | | |
| Comparative | magnet | 0.15 | 0.98 | 0.50 | 0.10 | bal. | 0.65 | 0.00 | 22.44 | 8.37 | 30.82 |
| Example 3 | | | | | | | | | | | |
| Comparative | magnet | 0.32 | 0.91 | 0.50 | 0.31 | bal. | 0.50 | 0.21 | 26.56 | 4.80 | 31.36 |
| Example 4 | | | | | | | | | | | |
| Comparative | magnet | 0.75 | 0.86 | 2.15 | 0.46 | bal. | 0.61 | 0.45 | 24.80 | 8.20 | 33.00 |
| Example 5 | | | | | | | | | | | |

TABLE 5
The secondary aging temperature in Comparative Examples 1 to 5

| | Compar- | Compar- | Compar- | Compar- | Compar- |
|---|---|---|---|---|---|
| | ative | ative | ative | ative | ative |
| | Exam- | Exam- | Exam- | Exam- | Exam- |
| | ple 1 | ple 2 | ple 3 | ple 4 | ple 5 |
| Secondary | 460° C. | 450° C. | 460° C. | 460° C. | 470° C. |
| aging | | | | | |
| temperature | | | | | |

The magnetic properties of the Examples and Comparative Examples are shown in Table 6. It can be seen from Table 6 that the magnetic properties in the Examples are higher than those in the Comparative Examples.

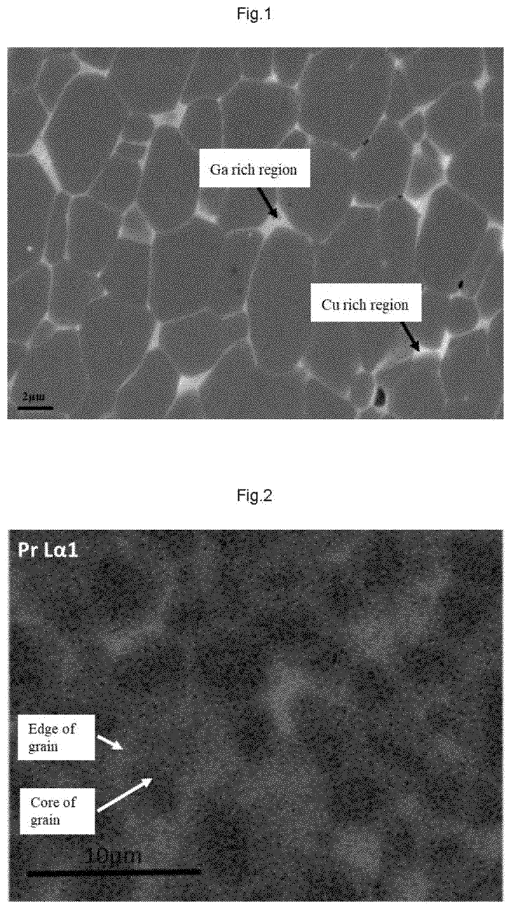

FIG. 1 is a microstructure image of the NdFeB magnet according to Example 1, it can be seen that the grain boundary phase is clear and continuous. A Ga rich region and Cu rich region exists in the triangle junctions of the magnet.

FIG. 2 illustrates the distribution of elemental Pr in the sintered NdFeB magnet according to Example 1. Areas of high content of Pr are grey and areas of low Pr content are black. The distribution of Pr element in grains is inhomogeneous and the content of Pr element in the core of grains is obviously less than that in the outer layer of the main phase grains, which indicates that a shell structure is formed in the outer layer of the main phase grains.

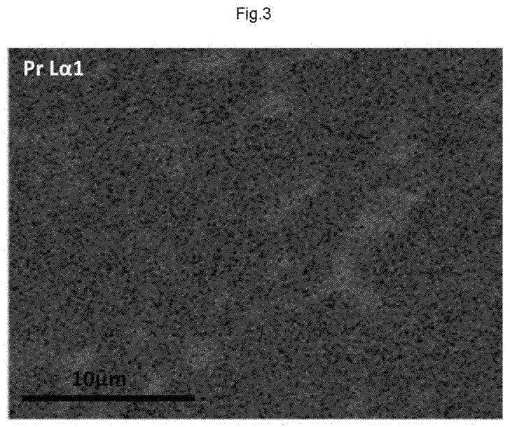

FIG. 3 shows the distribution of elemental Pr in the NdFeB magnet according to Comparative Example 1. It can be seen from the image that Pr in the grains distributes uniformly, which indicates that no shell structure is formed in the grains.

TABLE 6
The magnetic properties of the magnets

| | Br(T) | Hcj(kA/m) | (BH)ₘ(kJ/m³) | Hk/Hcj |
|---|---|---|---|---|
| Example 1 | 1.45 | 1337.3 | 416.3 | 0.99 |
| Example 2 | 1.45 | 1456.7 | 407.6 | 0.99 |
| Example 3 | 1.42 | 1536.3 | 392.4 | 0.99 |
| Example 4 | 1.38 | 1631.8 | 375.7 | 0.98 |
| Example 5 | 1.29 | 1870.6 | 320.8 | 0.98 |
| Comparative | 1.44 | 1217.9 | 398.8 | 0.98 |
| Example 1 | | | | |
| Comparative | 1.43 | 1241.8 | 394.0 | 0.98 |
| Example 2 | | | | |
| Comparative | 1.40 | 1353.2 | 382.9 | 0.98 |
| Example 3 | | | | |
| Comparative | 1.37 | 1520.4 | 367.0 | 0.98 |
| Example 4 | | | | |
| Comparative | 1.27 | 1743.2 | 314.4 | 0.97 |
| Example 5 | | | | |

The sintered NdFeB magnets according to Examples 1-5 show improved magnetic characteristics, in particular high remanence, high coercivity, and high magnetic energy. In addition, this method can significantly reduce the production cost.

What is claimed is:

1. A sintered NdFeB magnet comprising:
a main phase I consisting of Re₂Fe₁₄B, where Re is Nd or Pr and Nd;
a shell structure covering at least partially an outer layer of main phase I, the shell structure consisting of (PrNd)₂Fe₁₄B and having a thickness of 0.1-2 μm, and wherein the amount of Pr in the shell structure is 1 wt %˜7 wt %;
a grain boundary phase adjacent to shell structure;
a main phase II consisting of Pr₂Fe₁₄B;
a Ga rich region and a Cu rich region in a trigonal junction,
the amounts of Ga, Cu and Al in the Ga rich region are 2 wt %-5 wt %, 00.3 wt %, and 0˜1 wt %, respectively, and wherein a total mass fraction of Ga, Cu and Al is 2 wt %-6 wt % of the total mass of the Ga rich region;
the amounts of Ga, Cu and Al in the Cu rich region are 0 wt %˜0.4 wt %, 1 wt˜9 wt %, and 0˜0.5 wt %, respectively, and wherein a total mass fraction of Ga, Cu and Al is 2 wt %-9.9 wt % of the total mass of the Cu rich region;
a total mass of main phase I, shell structure, grain boundary phase, main phase II, Ga rich region and Cu rich region makes more than 97 wt. % of the NdFeB magnet and, if any, a residue comprises NdO, NdN, and unavoidable impurities.

2. The sintered NdFeB magnet of claim 1, wherein the composition of the NdFeB magnet is in weight percentage (Pr₁₋ₓNdₓ)ₐ₁—Fe_{1-a1-b1-c1}—B_{b1}-M1_{c1},
where x is the weight fraction of Nd of the total weight of Nd and Pr,
a1, b1 and c1 are the weight fractions in the NdFeB magnet composition,
M1 is at least Ga and Cu and, optionally, further includes at least one of Al, Co, Ti, Zr, V, Mo, and Nb,
70%<x<100%, 29.6%≤a1≤33%; 0.86%≤b1≤0.98%; and 0.5%≤c1 ≤4.5%, and
and the balance is Fe and unavoidable impurities.

3. The sintered NdFeB magnet of claim 1, wherein a mass ratio of Ga, Cu and Al fits the condition 1<(Ga+Al)/Cu≤8.

4. A method for producing the sintered NdFeB magnet as defined in claim 1, the method comprising the steps of:
(S1) Preparing a main alloy and an additive alloy by a strip casting process:
a composition of the additive alloy is in weight percentage Reₐ₂—Fe_{1-a2-b2-c2}B_{b2}-M2_{c2}, 38%≤a2≤50%; 0.35%≤b2≤1%; 2.5%≤c2≤12%; where Re is Pr or Pr and Nd, and when Re contains Nd, a mass fraction of Pr is >50 wt. %;
M2 is at least Ga and Cu and, optionally, further includes at least one of Al, Co, Ti, Zr, V, Mo, and Nb, wherein a total mass of Al, Cu, Ga is X₃, a total mass of M2 is X₄, and a ratio of X₃ to X₄ is 0.35<X₃/X₄<1; and
a composition of the main alloy is approximate to Nd₂Fe₁₄B, and
(S2) Preparing NdFeB powder by hydrogen treatment and jet milling of the main alloy and the additive alloy, wherein the powder includes 82 wt %-95 wt % of the main alloy and 5 wt %-18 wt % of the additive alloy, wherein the ratio and the composition of the main alloy and the additive alloy are selected such that the magnet has the composition (Pr₁₋ₓNdₓ)ₐ₁—Fe_{1-a1-b1-c1}—B_{b1}-M1_{c1},
where x is the weight fraction of Nd of the total weight of Nd and Pr,
a1, b1 and c1 are the weight fractions in the NdFeB magnet composition,
M1 is at least Ga and Cu and, optionally, further includes at least one of Al, Co, Ti, Zr, V, Mo, and Nb;
(S3) Compressing the NdFeB powder of step (S2) into compacts while applying an orienting magnetic field; and
(S4) Sintering the compacts in a vacuum furnace and then aging the sintered compacts to obtain the NdFeB magnet.

5. The method of claim 4, wherein the strip casting process of step (S1) is performed under argon, and a melting temperature is 1400 to 1500° C.

6. The method of claim 4, wherein the NdFeB powder after jet milling process of step (S2) has an average particle size of D50 of 2.5 μm to 5 μm.

7. The method of claim 4, wherein the orienting magnetic field of step (S3) is 1.8 to 2.5 T.

8. The method of claim 4, wherein a sintering temperature is 1020° C. to 1060° C. and a sintering time is 6 to 12 h in step (S4).

9. The method of claim 4, wherein the aging in step (S4) includes a first heat treatment at 800° C. to 900° C. for 3 to 5 hours and a second heat treatment at 440° C. to 540° C. for 3 to 6 hours.
